(19) United States
(12) Patent Application Publication
(10) Pub. No.: US 2013/0026235 A1
(43) Pub. Date: Jan. 31, 2013

(54) LASER SCANNERS HAVING DYNAMIC AIMING-SCANNING MODE

(71) Applicants: Vladimir Gurevich, Douglaston, NY (US); Peter Fazekas, Bayport, NY (US); Dariusz J. Madej, Shoreham, NY (US); Gary G. Schneider, Stony Brook, NY (US); Bruno Vande Vyvre, Westhampton, NY (US)

(72) Inventors: Vladimir Gurevich, Douglaston, NY (US); Peter Fazekas, Bayport, NY (US); Dariusz J. Madej, Shoreham, NY (US); Gary G. Schneider, Stony Brook, NY (US); Bruno Vande Vyvre, Westhampton, NY (US)

(73) Assignee: Symbol Technologies, Inc., Schaumburg, IL (US)

(21) Appl. No.: 13/193,752

(22) Filed: Jul. 29, 2011

(51) Int. Cl. G06K 7/14

(52) U.S. Cl. 235/462.21

(57) ABSTRACT

A method of operating a laser scanner for reading a barcode. The laser scanner is configured to operate in at least two operating modes including a scanning mode and an aiming mode. The method includes operating the laser scanner in the scanning mode after a trigger signal is generated by a trigger on the laser scanner, and decoding the electrical signal that is received from the photodetector when the laser scanner is in the scanning mode. If the electrical signal from the photodetector is not successfully decoded after a first predetermined time period since the trigger signal is generated, alternating the laser scanner between the aiming mode and the scanning mode.

### FIELD OF THE DISCLOSURE

The present disclosure relates generally to laser scanners for reading barcodes.

### BACKGROUND

Various electro-optical systems have been developed for reading optical indicia, such as barcodes. A barcode is a coded pattern of graphical indicia comprised of a series of bars and spaces of varying widths. In a barcode, the bars and spaces having differing light reflecting characteristics. Some of the barcodes have a one-dimensional structure in which bars and spaces are spaced apart in one direction to form a row of patterns. Examples of one-dimensional barcodes include Uniform Product Code (UPC), which is typically used in retail store sales. Some of the barcodes have a two-dimensional structure in which multiple rows of bar and space patterns are vertically stacked to form a single barcode. Examples of two-dimensional barcodes include Code 49 and PDF417.

A barcode generally can be read and decoded with barcode readers. One type of barcode readers is the imaging scanner that use one or more solid-state imagers for reading and decoding barcodes. A solid-state imager generally includes a plurality of photosensitive elements or pixels aligned in one or more arrays. Examples of solid-state imagers include charged coupled devices (CCD) or complementary metal oxide semiconductor (CMOS) imaging chips.

Another type of barcode readers is the laser scanner. A conventional laser scanner generates one or more moving beams of laser light from a reading laser. The beams sweep one or more scan lines across a barcode symbol that is located anywhere in a range of working distances from the laser scanner. The laser scanner obtains a continuous analog waveform corresponding to the light reflected or scattered from the barcode symbol. The laser scanner then decodes the waveform to extract information from the barcode symbol.

Reading distant bar-codes presents aiming challenges for linear readers, especially for miniature engines intended for integration in portable terminals. An engine has to provide a bright illumination line and an even brighter aiming dot at far distances. In the imaging engines, the illumination LEDs and aiming LEDs drive significant currents thus increasing the power consumption and size of the engine needed to dissipate heat. On another hand, laser engines draw much lower currents than the imagers. However, activating of an aiming dot in existing laser scanners brings an extra cost to the reader (a double-trigger or accelerometer) and makes the aiming process not intuitive (requires a second trigger pull or decode on a trigger release). It is desirable to have a better solution for providing an aiming at barcodes at long distances with long-range laser scanners.

### SUMMARY

In one aspect, the invention is directed to a method of operating a laser scanner for reading a barcode. The laser scanner is configured to operate in at least two operating modes including a scanning mode and an aiming mode. The method includes operating the laser scanner in the scanning mode after a trigger signal is generated by a trigger on the laser scanner, and decoding the electrical signal that is received from the photodetector when the laser scanner is in the scanning mode. If the electrical signal from the photodetector is not successfully decoded after a first predetermined time period since the trigger signal is generated, alternating the laser scanner between the aiming mode and the scanning mode, and decoding the electrical signal that is received from the photodetector when the laser scanner is in the scanning mode.

The advantages of the present invention will become apparent to those skilled in the art upon a reading of the following specification of the invention and a study of the several figures of the drawings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a laser scanner for reading barcode symbols in accordance with some embodiments.

FIG. 2 is a flowchart showing a method of operating a laser scanner for reading a barcode in accordance with some embodiments.

FIG. 3 depicts a laser scanner operating in the scanning mode in accordance with some embodiments.

FIGS. 4A-4B depict a laser scanner operating in the aiming mode in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

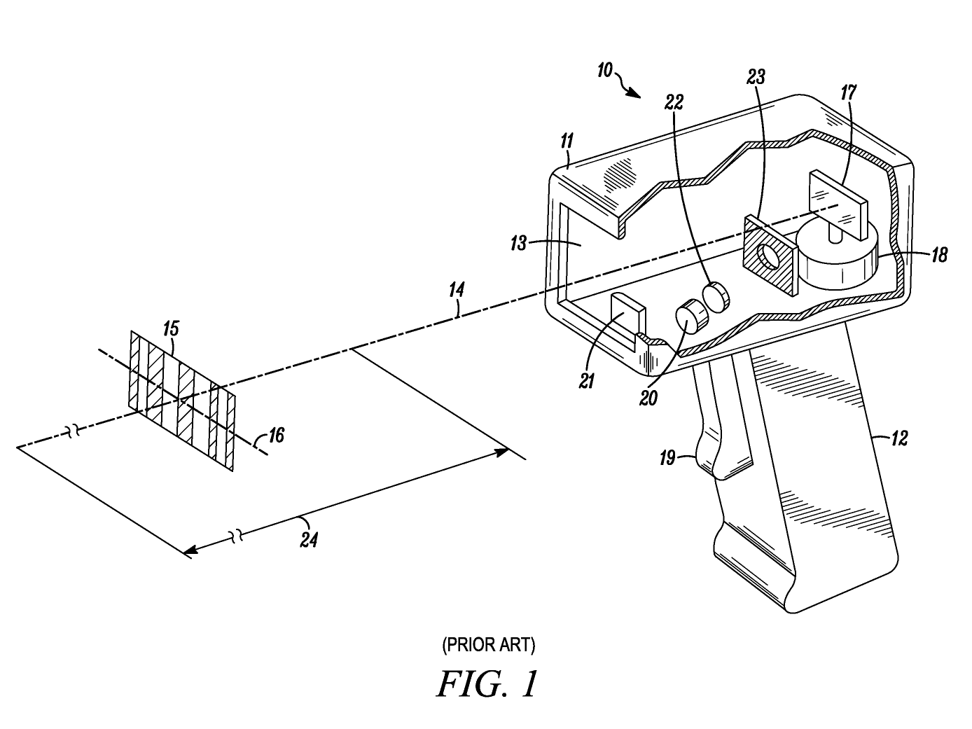

FIG. 1 depicts a laser scanner 10 for reading barcode symbols. The laser scanner 10 includes a housing 11 having a barrel portion and a handle. Although the drawing depicts a handheld pistol-shaped housing, the invention may also be implemented in other types of housings such as a desktop workstation or a stationary reader. In the illustrated embodiment, the housing 11 of the housing includes an exit port or window 13 through which an outgoing laser light beam 14 passes to impinge on, and sweep across, the barcode 15 located in a range 24 of working distances from the housing

The laser beam 14 moves across the barcode 15 to create a scan pattern. Typically, the scanning pattern is one-dimensional or linear, as shown by scan line 16. This linear scanning movement of the laser beam 14 is generated by an oscillating scan mirror 17 driven by an oscillating drive motor 18. If desired, means may be provided to scan the laser beam 14 through a two-dimensional scanning pattern, to permit reading of two-dimensional optically encoded symbols. A manually-actuated trigger 19 or the like permit an operator to initiate the scanning operation when the operator holds and aims the laser scanner 10 at the barcode 15.

The laser scanner 10 includes a reading laser 20 mounted within the housing. The reading laser 20 generates the laser beam 14. A photodetector 21 is positioned within the housing to collect at least a portion of the light reflected and/or scattered from the barcode 15. The photodetector 21, as shown, faces toward the window 13 and has a static, wide field of view characteristic of a non-retro-reflective reader. Alternatively, in a retro-reflective reader, a convex portion of the scan mirror 17 may focus collected light on the photodetector 21, in which case, the photodetector 21 faces toward the scan mirror. As the laser beam 14 sweeps the barcode 15, the photodetector 21 detects the light reflected and/or scattered from the barcode 15 and creates an analog electrical signal proportional to the intensity of the collected light.

A digitizer (not shown) typically converts the analog signal into a pulse width modulated digital signal, with the pulse widths and/or spacings corresponding to the physical widths of the bars and spaces of the scanned barcode 15. A decoder (not shown), typically comprising a programmed microprocessor with associated RAM and ROM, decodes the pulse width modulated digital signal according to a specific symbology to derive a binary representation of the data encoded in the symbol, and the alphanumeric characters represented by the symbol.

The reading laser 20 directs the laser beam through an optical assembly comprising a focusing lens 22 and preferably an aperture stop 23, to optically modify and direct the laser beam onto the scan mirror 17. The scan mirror 17, mounted on a vertical shaft and oscillated by the drive motor 18 about a vertical axis, reflects the beam and directs it through the window 13 to the barcode 15.

To operate the laser scanner 10, the operator depresses trigger 19, which activates the reading laser 20 and the drive motor 18. The reading laser 20 generates the laser beam that passes through the lens 22 and the aperture 23. The lens 22 and the aperture 23 modify the beam to create an intense beam spot of a given size that extends continuously and does not vary substantially over the range 24 of working distances. The lens and the aperture direct the beam onto the scan mirror 17, which directs the modified laser beam outwardly from the housing 11 and toward the barcode 15 in a sweeping pattern, i.e., along scan line 16. The barcode 15, placed at any point within the working distance range 24 and substantially normal to the laser beam 14, reflects and/or scatters a portion of the laser light. The photodetector 21, shown mounted in the housing 11 in a non-retro-reflective position, detects the reflected and/or scattered light and converts the received light into an analog electrical signal. The photodetector could also be mounted in a retro-reflective position facing the scan mirror 17. The system circuitry then converts the analog signal to a pulse width modulated digital signal that a microprocessor-based decoder decodes according to rules of the symbology of the type of symbol being read.

Hand-held laser scanners require a user to properly aim the scanner towards the desired barcode to be read. When such desired barcode is located at a long distance from the scanner, a user may want to operate the laser scanner in an aiming mode to project an aiming dot onto this barcode. In known laser scan engines, the aiming mode can be activated by pressing a trigger of the host terminal In order to switch to a scanning mode, the user should either release the trigger or press a second trigger. The first way is regarded by most users as a very non-intuitive scanning process; the second way increases the cost of the host terminal Another known solution employs an accelerometer that automatically turns on the aiming dot when a user picks up the scanner; then the user activates the scanning by pressing a trigger. This solution is also expensive. It is desirable to provides a low-power, low-cost, small-size, highly intuitive aiming solution for an aiming at bar-codes at long distances with a laser engine for using in long-range laser scanners

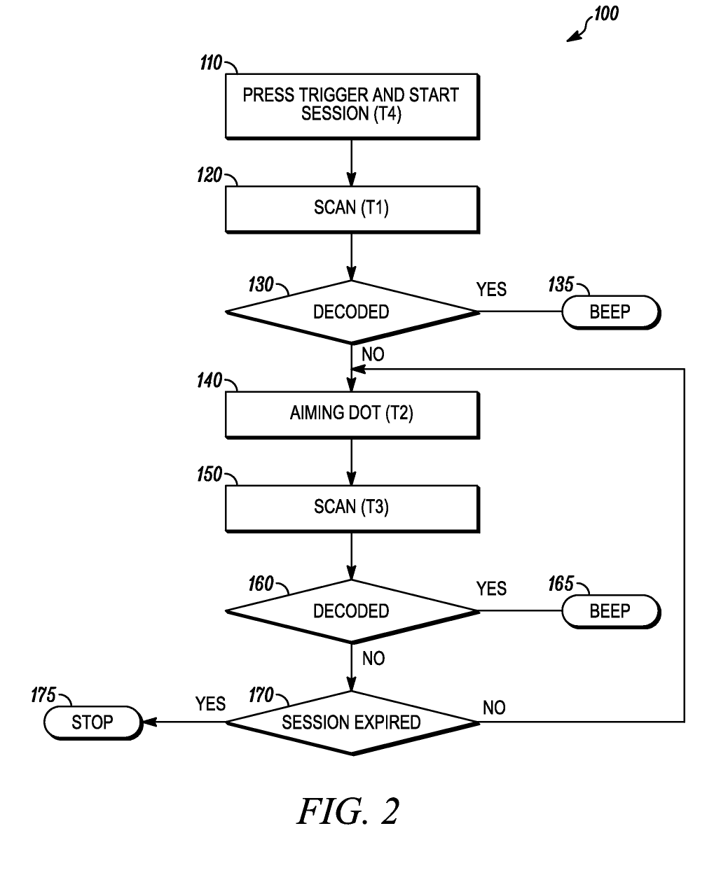

FIG. 2 is a flowchart showing a method 100 of operating a laser scanner for reading a barcode in accordance with some embodiments. The method 100 enables a user to aim the laser scanner at barcode in a dynamic aiming-scanning mode. As shown in FIG. 2, after a user pressed a trigger at block 110, the normal scanning process is activated (scan mirror is moving) at block 120. If decoding takes place at block 130 with a pre-set time T1 (for example, 2 second), the scanner beeps at block 135 and process terminates. However, at block 130, if there is no decoding within time T1, the process does not stop. Instead, the system automatically alternates between the aiming (mirror is stopped) at block 140 and scanning (mirror is moving) at block 150. At block 140, a user will see a blinking aiming dot which is much brighter than the scan line at block 150. After he or she places the aiming dot on a bar-code, the bar-code is decoded as soon as the aiming dot is automatically replaced with the scanning line.

If the decoding is successful at block 160, the scanner beeps at block 135 and process terminates. If the decoding is not successful at block 160, the scanner determines whether a session is expired at block 170. If the session is not expired, the operating mode of the scanner changes from the scanning mode to the aiming mode at block 140, and the aiming dot is generated. If the session is expired, the process terminates at block 175. In one implementation, the session is expired after the predetermined session duration T4 after the trigger is pressed at block 110.

In most of the cases, the user will pull the trigger and immediately read a bar-code, without seeing an aiming dot. However, when a bar-code is very far or brightly illuminated, the user might not see the scan line. If he or she does not put the scan line accidentally on a bar-code, the aiming dot will be generated automatically. The aiming and scanning durations can be programmed using, for example, a set of parameter bar-codes. It also can be programmed if the scanner starts from conventional scanning or directly from the aiming/scanning sequence.

In the embodiments as shown in FIG. 2, at block 140, the laser scanner can operate in the aiming mode for a predetermined aiming duration T2; at block 150, the laser scanner can operate in the scanning mode for a predetermined scanning duration T3. Both the predetermined aiming duration and the predetermined scanning duration can be programmable. Quite often, the predetermined aiming duration T2 is set in the range from 0.2 second to 2 second, and the predetermined scanning duration T3 is set in the range from 0.2 second to 2 second.

The proposed low-power, low-cost, intuitive aiming solution can be implemented directly in miniature scan engines while not requiring any special aiming features in a host terminal The proposed dynamic aiming/scanning mode does not introduce any inconvenience in the bar-code scanning process while automatically assisting any non-trained user with aiming dot when he or she needs it.

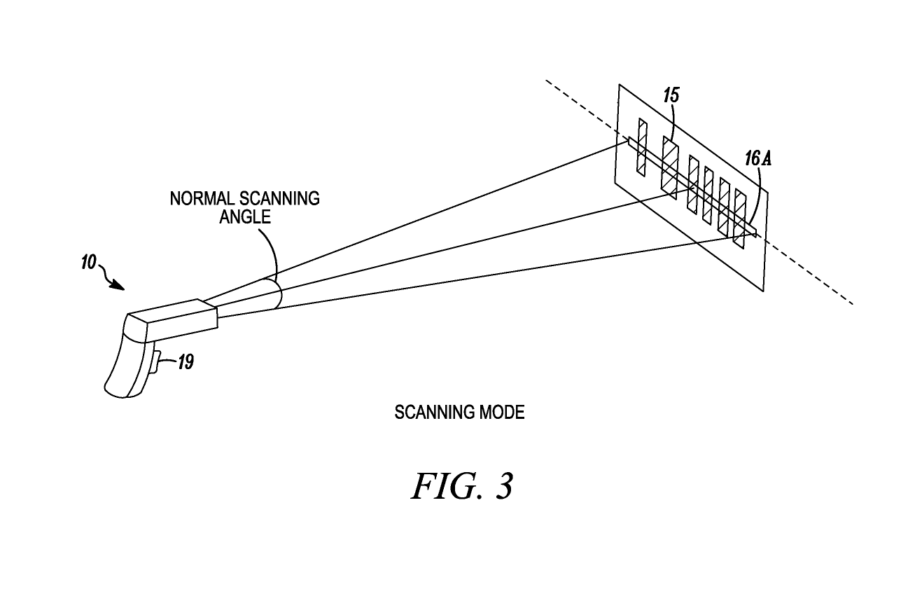

FIG. 3 depicts a laser scanner 10 operating in the scanning mode in accordance with some embodiments. In FIG. 3, when the laser scanner is operating in the scanning mode, a user can place a scan line 16A on the barcode 15. In the scanning mode, the scan line 16A is formed when a scanning laser beam scans across the barcode 15 with a normal scanning angle as the scan mirror making oscillating movement. As shown in FIG. 3, when the laser scanner is operating in the scanning mode, the scanning laser beam generally has a normal scanning angle. In FIG. 2, the laser scanner operates in the scanning mode at block 120 and at block 150. The normal scanning angle of the scanning laser beam at block 120 can be the same or different from that at block 150. In addition, the normal scanning angle of the scanning laser beam at block 150 can also be the same or different between different iterations of the scanning mode.

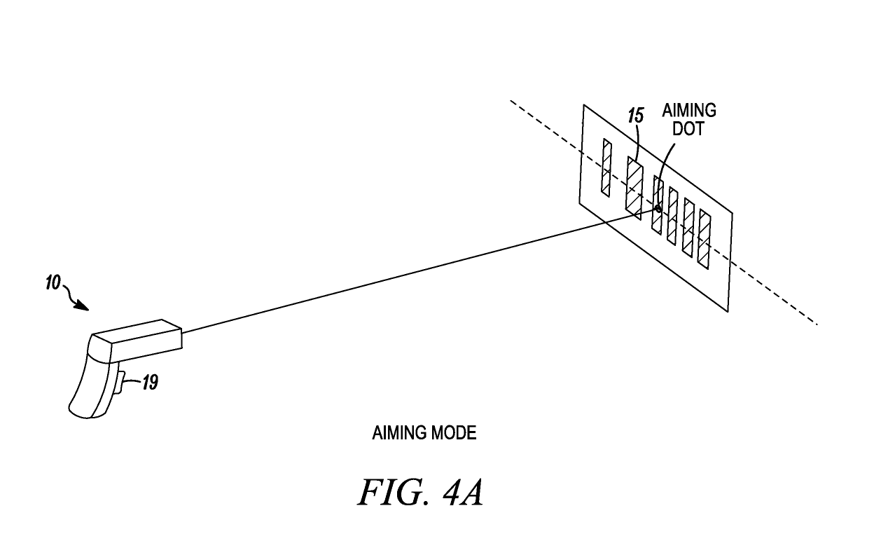

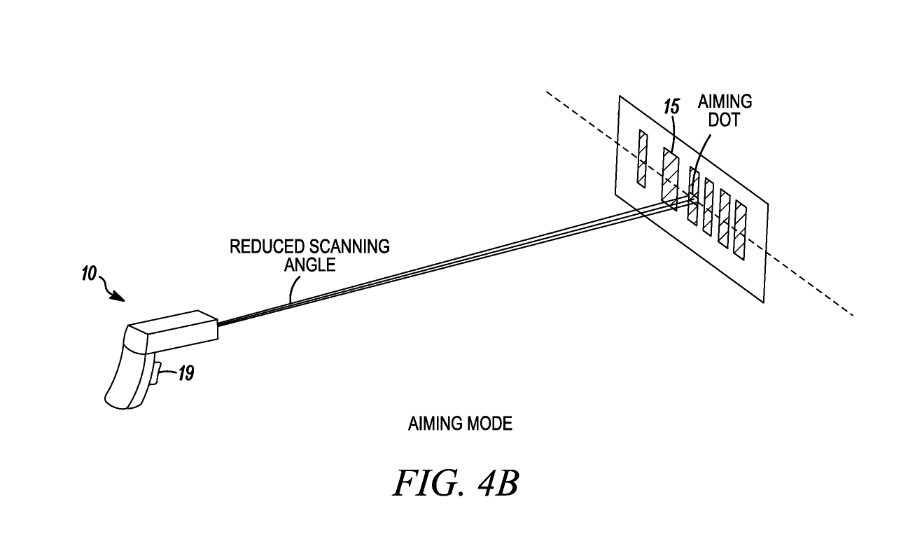

FIGS. 4A-4B depict a laser scanner 10 operating in the aiming mode in accordance with some embodiments. In FIG. 2, the laser scanner operates in the aiming mode at block 140. In FIGS. 4A-4B, when the laser scanner is operating in the aiming mode, a user can place an aiming dot 16B on the barcode 15. In the aiming mode as shown in FIG. 4A, the aiming dot 16B is formed when the scan mirror is kept substantially stationary. In the aiming mode as shown in FIG. 4B, the aiming dot 16B is formed when a scanning laser beam scans across the barcode 15 with a reduced scanning angle as the scan mirror making oscillating movement. The reduced scanning angle in FIG. 4B generally is significantly smaller than the normal scanning angle in FIG. 3. For example, the reduced scanning angle can be less than 5% or 10% of the normal scanning angle.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of operating a laser scanner for reading a barcode, the laser scanner comprising (1) a scan mirror reflecting a laser beam towards the barcode and generating a scanning laser beam across the barcode as the scan mirror making oscillating movement and (2) a photodetector configured to detect returned light from the barcode when the scanning laser beam is incident upon the barcode, wherein the laser scanner is configured to operate in at least two operating modes including a scanning mode and an aiming mode, the method comprising:
operating the laser scanner in the scanning mode after a trigger signal is generated by a trigger on the laser scanner, moving the scan mirror during the scanning mode to generate the scanning laser beam with a normal scanning angle and receiving an electrical signal from the photodetector while the laser scanner is in the scanning mode, and decoding the electrical signal; and
if the electrical signal from the photodetector is not successfully decoded after a first predetermined time period since the trigger signal is generated, alternating the laser scanner between the aiming mode and the scanning mode, and decoding the electrical signal that is received from the photodetector when the laser scanner is in the scanning mode.

2. The method of claim 1, comprising:
keeping the scan mirror substantially stationary during the aiming mode.

3. The method of claim 1, comprising:
moving the scan mirror during the aiming mode to generate the scanning laser beam with a reduced scanning angle that is less than 5% of the normal scanning angle.

4. The method of claim 1, comprising:
moving the scan mirror during the aiming mode to generate the scanning laser beam with a reduced scanning angle that is less than 10% of the normal scanning angle.

5. The method of claim 1, wherein said alternating the laser scanner between the aiming mode and the scanning mode comprise:
operating the laser scanner in the aiming mode for a predetermined aiming duration and operating the laser scanner in the scanning mode for a predetermined scanning duration.

6. The method of claim 5, wherein at least one of the predetermined aiming duration and the predetermined scanning duration is programmable.

7. The method of claim 5, wherein the predetermined aiming duration is between 0.2 second to 2 second.

8. The method of claim 5, wherein the predetermined scanning duration is between 0.2 second to 2 second.

9. The method of claim 1, comprising:
determining whether a session is expired; and
if the session is expired, terminating said alternating the laser scanner between the aiming mode and the scanning mode.

10. The method of claim 9, wherein the session is expired after a predetermined session duration since the trigger signal is generated.

11. A method of operating a laser scanner for reading a barcode, the laser scanner comprising (1) a scan mirror reflecting a laser beam towards the barcode and generating a scanning laser beam across the barcode as the scan mirror making oscillating movement and (2) a photodetector configured to detect returned light from the barcode when the scanning laser beam is incident upon the barcode, the method comprising:
alternating the laser scanner between an aiming mode and a scanning mode after a trigger signal is generated by a trigger on the laser scanner, moving the scan mirror during the scanning mode to generate the scanning laser beam with a normal scanning angle, and decoding an electrical signal that is received from the photodetector when the laser scanner is in the scanning mode.
determining whether a session is expired; and
if the session is expired, terminating said alternating the laser scanner between the aiming mode and the scanning mode.

12. The method of claim 11, comprising:
alternating the laser scanner between the aiming mode and the scanning mode by starting with the aiming mode after the trigger signal is generated.

13. The method of claim 11, comprising:
alternating the laser scanner between the aiming mode and the scanning mode by starting with the scanning mode after the trigger signal is generated.

14. The method of claim 11, comprising:
keeping the scan mirror substantially stationary during the aiming mode.

15. The method of claim 11, comprising:
moving the scan mirror during the aiming mode to generate the scanning laser beam with a reduced scanning angle that is less than 10% of the normal scanning angle.

16. The method of claim 11, wherein said alternating the laser scanner between the aiming mode and the scanning mode comprise:
operating the laser scanner in the aiming mode for a predetermined aiming duration and operating the laser scanner in the scanning mode for a predetermined scanning duration.

17. A laser scanner for reading a barcode comprising:
a housing having a barrel portion and a handle;
a trigger on the handle;
a reading laser for generating a laser beam;
a scan mirror reflecting the laser beam towards the barcode and generating a scanning laser beam across the barcode as the scan mirror making oscillating movement;
a photodetector configured to detect returned light from the barcode when the scanning laser beam is incident upon the barcode; and
a controller configured for
alternating the laser scanner between an aiming mode and a scanning mode after a trigger signal is generated by the trigger, moving the scan mirror during the scanning mode to generate the scanning laser beam with a normal scanning angle, and decoding an electrical signal that is received from the photodetector when the laser scanner is in the scanning mode,
determining whether a session is expired, and
if the session is expired, terminating said alternating the laser scanner between the aiming mode and the scanning mode.

18. The laser scanner of claim 17, wherein the controller configured for
alternating the laser scanner between the aiming mode and the scanning mode by starting with the aiming mode after the trigger signal is generated.

19. The laser scanner of claim 17, wherein the controller configured for
alternating the laser scanner between the aiming mode and the scanning mode by starting with the scanning mode after the trigger signal is generated.

20. The laser scanner of claim 17, wherein the controller configured for keeping the scan mirror substantially stationary during the aiming mode.

21. The laser scanner of claim 17, wherein the controller configured for
moving the scan mirror during the aiming mode to generate the scanning laser beam with a reduced scanning angle that is less than 10% of the normal scanning angle.

22. The laser scanner of claim 17, wherein the controller configured for
alternating the laser scanner between the aiming mode for a predetermined aiming duration and the scanning mode for a predetermined scanning duration.
